(19) United States
(12) Patent Application Publication
(10) Pub. No.: US 2016/0214238 A1
(43) Pub. Date: Jul. 28, 2016

(54) PNEUMATIC TOOL HAVING AN IMPACT MODULE WITH DUAL IMPACT

(71) Applicant: STORM PNEUMTIC TOOL CO., LTD., TAICHUNG CITY (TW)

(72) Inventor: YUNG YUNG SUN, TAICHUNG CITY (TW)

(21) Appl. No.: 14/603,738

(22) Filed: Jan. 23, 2015

(51) Int. Cl. B25B 21/02

(52) U.S. Cl. CPC B25B 21/02

(57) ABSTRACT

A pneumatic tool having an impact module with dual impact members includes a driving motor, a driving shaft protruded from the driving motor, a driving section and an extension driving shaft formed along the protruding direction of the driving shaft, an impact module for connecting the driving motor, a rotating space formed in the impact module, two impact members pivotally installed in the rotating space, and each having a forward striking portion and a reverse striking portion, and the forward striking portion having a protruding length greater than the protruding length of the reverse striking portion, and an anvil shaft passing through the rotating space and having an anvil portion corresponsive to the forward striking portion and the reverse striking portion of each impact member, and a circular hole formed at opposite end surfaces of the anvil shaft and the driving motor for passing the extension of the driving shaft.

### FIELD OF THE INVENTION

The present invention relates to an impact type pneumatic tool, and more particularly to a pneumatic tool having an impact module with dual impact members.

### BACKGROUND OF THE INVENTION

In a conventional impact type pneumatic tool, a pneumatic motor is provided for driving an impact module to rotate, and an impact member installed in the impact module is provided for striking an anvil shaft, such that the anvil shaft generates a rotation power with an impact effect to achieve the effect of tightening or loosening a bolt or a nut. The design of the impact module of the conventional impact type pneumatic tool may include a single impact member or dual impact members.

With reference to FIG. 7 for a conventional design of an impact module having a single impact member, the center of gravity of the impact module 91 is not situated at its balanced point, thus producing vibrations. To reduce the vibration during the rotation of the impact module 91, it is necessary to add an eccentric weight portion 93 to the design of such impact module 91 having only one impact member 92. In practices, the additional installation of the weight portion 93 not just increases the volume of the impact module only, but also requires repeated calculations, modifications and testing of the eccentric position and weight in the development stage. In addition, the impact type pneumatic tools with different specifications and sizes require different designs for the weight portion 93.

With reference to FIG. 8 for a conventional design of an impact module having dual impact members, the impact module has a housing formed by a frame 94, and an accommodating space 96 formed inside the housing for accommodating two impact members 95. However, the impact module with the aforementioned structural design simply has two support walls disposed at both ends of the frame 94 and connected to two upper and lower ribs 941. Obviously, such structural strength is unsatisfactory. To increase the strength of the frame 94, it is necessary to increase the thickness of the rib 941, and thus the accommodating space 96 must be reduced accordingly, and the reduced accommodating space 96 can accommodate a smaller impact member 95 only and results in a lower impact performance. If the dimensions of the frame 94 are increased to enhance the structural strength, then the volume of the impact module will be increased significantly.

With reference to FIG. 9 for another conventional design of an impact module having dual impact members, the impact module has two impact members 98 arranged adjacent to each other and one in front of the other, and the two impact members are installed in opposite direction inside the impact module 97. In addition, each of the two impact members 98 has a special maple-leaf shaped opening formed at the center of the impact member 98, and thus a sharp corner may be formed at the inner side of the opening of such impact member 98. As a result, an anvil shaft 99 may be worn or damaged easily, and the manufacture is relatively difficult and usually unable to meet the precision requirement.

In addition, all designs of the aforementioned conventional impact modules do not have any support structure on the anvil shaft, so that there is an issue of shaking and shifting the anvil shaft easily when it is struck by the impact member, and the performance of output will be reduced. In a general operation of securing a screw, it simply requires to maintain a specific output of the torque when the screw is secured in a forward direction, but it requires a greater output of the torque when the screw is loosened in a reverse direction, so that a screw being situated at a fixed condition for a long time can be loosened successfully. However, all conventional designs of the aforementioned impact modules have the same impact stroke when the impact member is rotated in both forward and reverse directions, so that the outputs of the torque provided for securing as well loosening the screw are the same, and a greater torque cannot be provided when loosening the screw in the reverse direction, and the conventional designs fail to meet the actual using requirements.

In view of the aforementioned drawbacks of the prior art, the inventor of the present invention conducted extensive researches and experiments and finally developed a pneumatic tool having an impact module with dual impact members in accordance with the present invention to overcome the drawbacks of the prior art.

### SUMMARY OF THE INVENTION

Therefore, it is a primary objective of the present invention to provide a pneumatic tool having an impact module with dual impact members, and the pneumatic tool is capable of producing a greater output of torque in a reverse rotation, so as to make the job of loosening a screw more efficiently.

A secondary objective of the present invention is to provide a pneumatic tool having an impact module with dual impact members, and the pneumatic tool is capable of reducing the level of shaking and shifting an anvil shaft during an operation, so as to ensure the output performance of the pneumatic tool.

A tertiary objective of the present invention is to provide a pneumatic tool having an impact module with dual impact members, and the pneumatic tool is capable of still maintaining the stability of the rotation of the impact module without requiring the installation of a weight portion at the eccentric position.

A quaternary objective of the present invention is to provide a pneumatic tool having an impact module with dual impact members, and the impact module has the advantages of easy assembling process and good structural strength, and the impact member can be manufactured easily, and the expected precision requirement can be achieved easily.

To achieve the aforementioned and other objectives, the present invention provides a pneumatic tool having an impact module with dual impact members, comprising:

a handle, having a driving motor installed at an end of the handle, a driving shaft protruded outwardly from the driving motor, and a driving section and a cylindrical extension with an external diameter smaller than the driving section sequentially formed along the protruding direction of the driving shaft; and

an impact module, with an end coupled to the driving shaft of the driving motor, and including a rotating socket, a transmission seat, two impact members, a latch ring and an anvil shaft, and the rotating socket having a rotating space formed therein, and an outer wall and an inner wall, and the rotating space and the rotating socket being configured coaxially with each other, and two symmetrical pivoting slots being concavely formed on the inner wall, and an opening being formed at an end of the rotating socket and interconnected to the rotating space, and a rear side being formed at the other end of the rotating socket, and a via is formed at the center of the rear side of the rotating socket and interconnected to the rotating space, and an end of the transmission seat being disposed corresponsive to the via of the rotating socket, an embedding hole being formed at the center of the transmission seat, and the driving section of the driving shaft being embedded into the embedding hole and capable of driving the transmission seat to rotate, and two limit slots concavely formed at the other end of the transmission seat and in opposite directions with respect to each other.

Wherein, each of the two impact members has an integrally connected pivoting portion, a forward striking portion protruded from a side of the pivoting portion, a reverse striking portion protruded from the other side of the pivoting portion, and a limit protrusion, and the forward striking portion has a protruding length greater than the protruding length of the reverse striking portion, and the pivoting portions of the two impact members are respectively and pivotally installed into the two pivoting slots of the rotating socket, and the limit protrusions are latched into the two limit slots of the transmission seat respectively, and the forward striking portion of one of the two impact members is arranged opposite to the reverse striking portion of the other impact member, and the latch ring is covered onto the opening of the rotating socket, and a through hole is formed at the center of the latch ring and interconnected to the rotating space.

The anvil shaft has an actuating end and a transmitting end disposed opposite to the actuating end, and the actuating end of the anvil shaft axially passes into the rotating space of the rotating socket through the through hole of the latch ring and abuts the transmission seat, and the actuating end has a circumferential surface and a bottom side abutting at the transmission seat, two anvil portions formed and protruded from the forward striking portion and the reverse striking portion at the circumferential surface and corresponsive to the two impact members respectively, and a circular hole concavely formed axially at the center of the bottom side of the actuating end, and the extension of the transmission shaft passes into the circular hole, and the extension passes into the circular hole to a length greater than half of the depth of the circular hole, such that when the driving shaft drives the transmission seat to rotate, the two impact members and the rotating socket are rotated altogether, and the forward striking portions of the two impact members strike the corresponsive anvil portion of the anvil shaft simultaneously in a forward rotation process, and a first striking surface and a second striking surface are defined at cross-sectional positions respectively, and the first striking surface and the second striking surface are configured to be parallel to each other, and the reverse striking portions of the two impact members strike the anvil portion of the anvil shaft simultaneously in a reverse rotation process, and a third striking surface and a fourth striking surface are defined at cross-sectional positions respectively, and the third striking surface and the fourth striking surface are configured to be parallel to each other.

### BRIEF DESCRIPTION OF THE DRAWINGS

FIG. 1 is an exploded view of the present invention;

FIG. 2 is a schematic planar view of the present invention;

FIG. 3 is a perspective view of the present invention;

FIG. 4 is a partial cross-sectional view of the present invention;

FIG. 5 is a schematic view of an impact module rotating in a forward direction in accordance with the present invention;

FIG. 6 is a schematic view of an impact module rotating in a reverse direction in accordance with the present invention;

FIG. 7 is a schematic view of a conventional impact module having a single impact member;

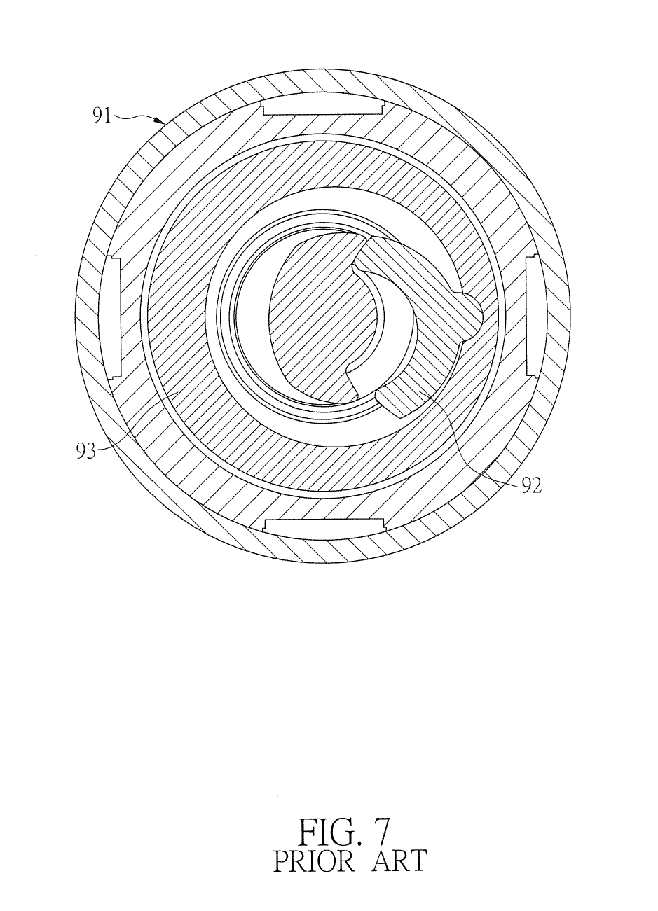

FIG. 8 is a schematic view of a conventional impact module having dual impact members; and

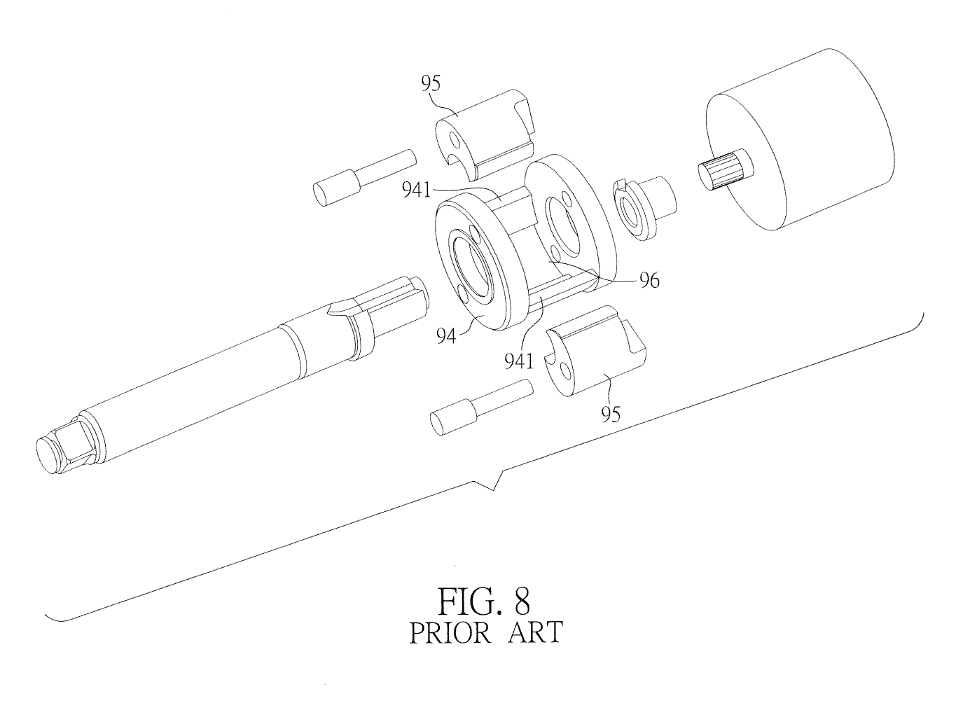

FIG. 9 is a schematic view of another conventional impact module having dual impact members.

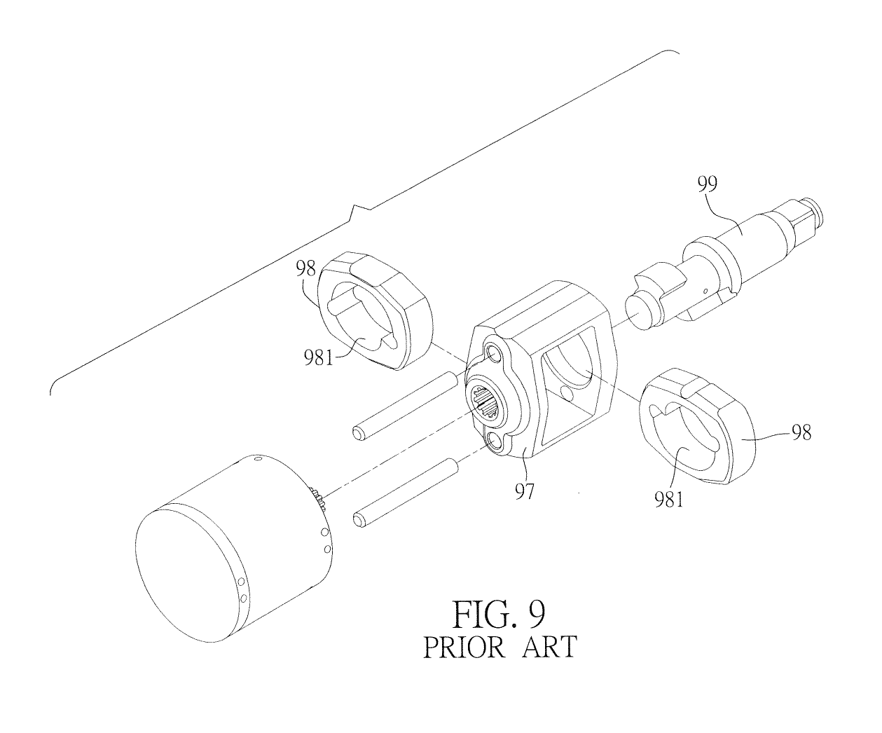

### DESCRIPTION OF THE PREFERRED EMBODIMENTS

The technical characteristics, contents, advantages and effects of the present invention will be apparent with the detailed description of a preferred embodiment accompanied with related drawings as follows.

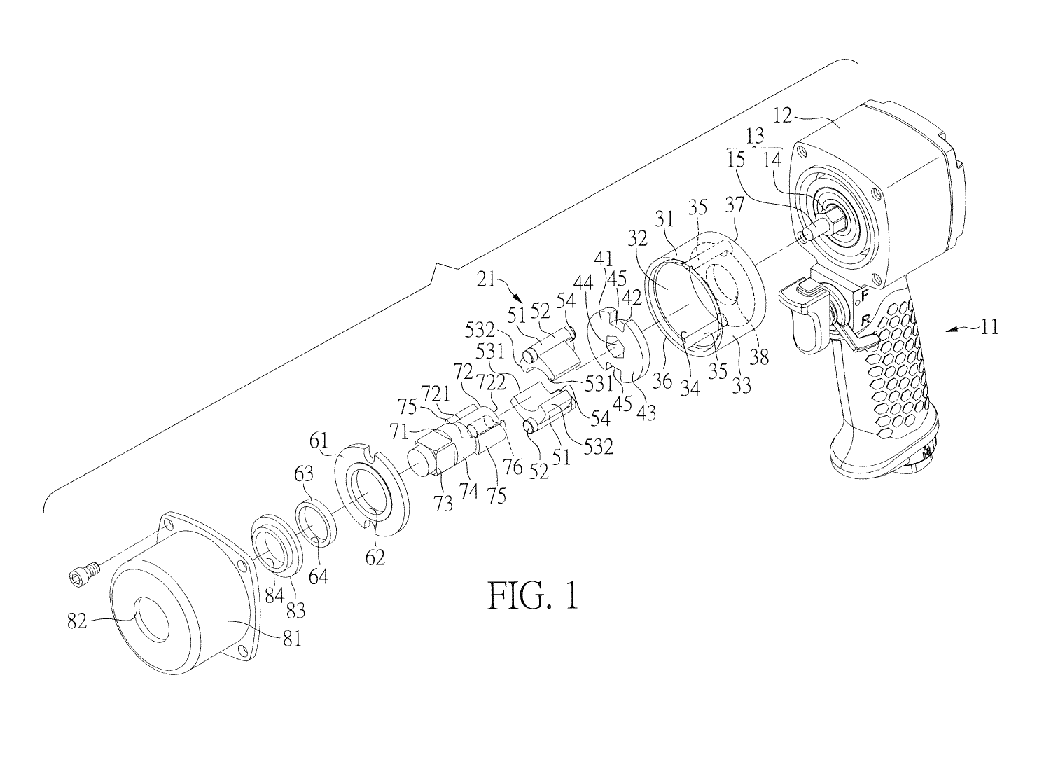

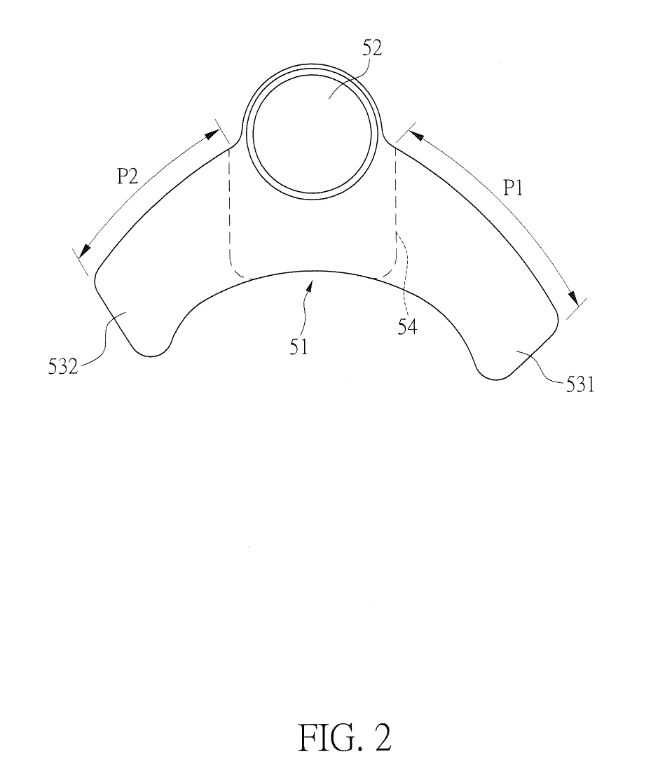

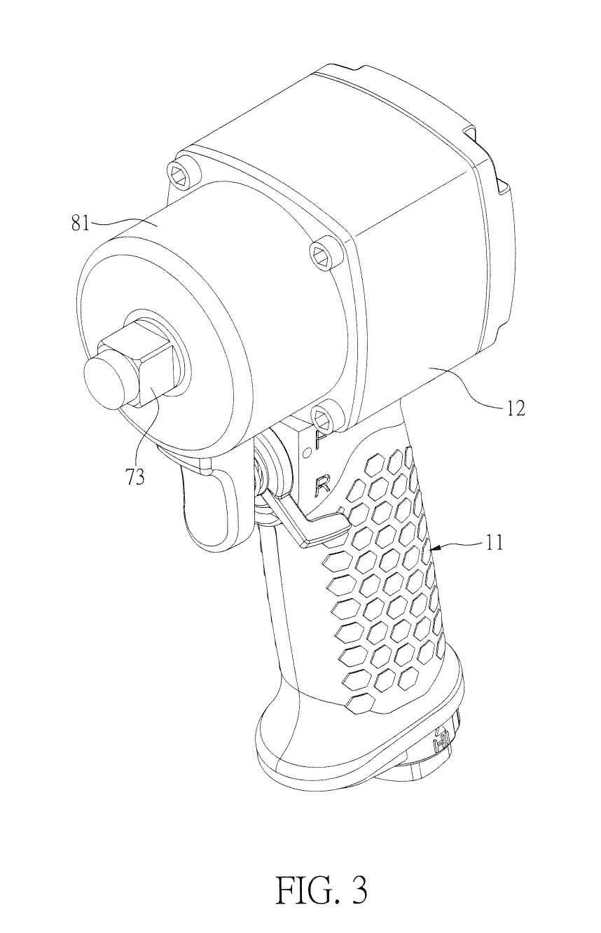

With reference to FIGS. 1 to 4 for a pneumatic tool having an impact module with dual impact members in accordance with the present invention, the pneumatic tool comprises a handle 11, an impact module 21 and a housing 81.

The handle 11 has a driving motor 12 installed at an end of the handle 11, and a driving shaft 13 is protruded outwardly from the driving motor 12 and driven by the driving motor 12 to rotate in forward and reverse directions, and a driving section 14 and a cylindrical extension 15 with an external diameter smaller than the driving section 14 are sequentially formed along the protruding direction of the driving shaft 13.

The impact module 21 has an end coupled to the driving shaft 13 of the driving motor 12, and the impact module 21 includes a rotating socket 31, a transmission seat 41, two impact members 51, a latch ring 61 and an anvil shaft 71. The rotating socket 31 is in a hollow cylindrical form and has a rotating space 32 formed therein, and an outer wall 33 and an inner wall 34, and the rotating space 32 and the rotating socket 22 are configured coaxially with each other, and two symmetrical pivoting slots 35 are concavely formed on the inner wall 34. More specifically, the two pivoting slots 35 are extended parallel to the axial direction of the rotating socket 31 and concavely formed on two opposite sides of the inner wall 34 respectively. In addition, an opening 36 is formed at an end of the rotating socket 31 and interconnected to the rotating space 32, and a rear side 37 is formed at the other end of the rotating socket 31, and a via 38 is formed at the center of the rear side 37 of the rotating socket 31 and interconnected to the rotating space 32.

The transmission seat 41 has an installing end 42 formed at an end and a receiving end 43 expanded and formed at the other end, and the installing end 42 of the transmission seat 41 is installed into the via 38 of the rear side 37 of the rotating socket 31 through the opening 36 of the rotating socket 31, and an embedding hole 44 is formed at the center of the transmission seat 41 and penetrated through the installing end 42 and the receiving end 43, wherein the embedding hole 44 is in a shape corresponsive to the shape of the driving section 14 of the transmission shaft 13, and the driving section 14 of the driving shaft 13 is embedded into the embedding hole 44 of the transmission seat 41 through the rear side 37 of the rotating socket 31. In this preferred embodiment, the embedding hole 44 and the driving section 14 constitute a hexagonal shape, such that the driving section 14 of the driving shaft 13 can be embedded into the embedding hole 44 and provided for driving the transmission seat 41 to rotate, and two limit slots 45 are concavely formed at the external periphery of the transmission seat 41 and arranged in opposite directions with respect to each other.

Each of the two impact members 51 is integrally coupled to a pivoting portion 52, and an arc-shaped forward striking portion 531 is protruded from a side of the pivoting portion 52, and an arc-shaped a reverse striking portion 532 is protruded from the other side of the pivoting portion 52, and a limit protrusion 54 is disposed at an end where the pivoting portion 52 is connected to the forward striking portion 531 and the reverse striking portion 532, and the forward striking portion 531 has a protruding length P1 greater than the protruding length P2 of the reverse striking portion 532, and the pivoting portions 52 of the two impact members 51 are respectively and pivotally installed into the two pivoting slots 35 of the rotating socket 31, and the limit protrusions 54 are latched into two limit slots 45 of the transmission seat 41 respectively, and the forward striking portion 531 of one of the two impact members 51 is arranged opposite to the reverse striking portion 532 of the other impact member 51. Wherein, each limit protrusion 54 has an external diameter smaller than the width between two sides of the limit slot 45, so that each impact member 51 can be pivoted by using the pivoting slot 35 as an axis, and the limit slot 45 can be used to limit the pivoting amplitude of each impact member 51.

The latch ring 61 is covered onto the opening 36 of the rotating socket 31, and a through hole 62 is formed at the center of the latch ring 61 and interconnected to the rotating space 32, and a first support ring 63 is installed in the through hole 62, and a circular first support surface 64 is formed around the interior of the first support ring 63, and the first support ring 63 has a peripheral shape corresponsive to the shape of the through hole 62.

The anvil shaft 71 is a rod extended along a front-to-rear direction and has an actuating end 72 and a transmitting end 73 opposite to the actuating end 72, and a connecting portion 74 is formed and defined between the actuating end 72 and the transmitting end 73, and the connecting portion 74 has a peripheral shape corresponsive to the first support surface 64 of the first support ring 63, and the actuating end 72 of the anvil shaft 71 passes axially into the rotating space 32 of the rotating socket 31 through the through hole 62 of the latch ring 61 and abuts against the receiving end 43 of the transmission seat 41, and the actuating end 72 has a circumferential surface 721, and a bottom side 722 abutting the receiving end 43 of the transmission seat 41, and two symmetric anvil portions 75 are protruded from positions of the circumferential surface 721 corresponsive to the forward striking portion 531 and the reverse striking portion 532 of the two impact members 51 respectively, and a circular hole 76 is concavely formed at the center of the bottom side 722 of the actuating end 72 and in an axial direction, and the extension 15 of the transmission shaft 13 passes into the circular hole 76, and the extension 15 passes into the circular hole 76 to a length greater than half of the depth of the circular hole 76. When the bottom side 722 of the actuating end 72of the anvil shaft 71 abuts the receiving end 43 of the transmission seat 41, the first support ring 63 of the latch ring 61 is sheathed on the external periphery of the connecting portion 74 of the anvil shaft 71.

The housing 81 is covered around the external periphery of the impact module 21 and coupled to the driving motor 12, and a transmission hole 82 is formed at an end of the housing 81, and the transmitting end 73 of the anvil shaft 71 is passed through the transmission hole 82 and exposed from the housing 81, and the transmission hole 82 of the housing 81 has a second support ring 83, and a circular second support surface 84 is formed around the interior of the second support ring 83, and the second support surface 84 and the first support surface 64 of the first support ring 63 have the same shape and size, so that when the housing 18 and the driving motor 12 are connected, the second support ring 83 of the housing 81 is also sheathed on the external periphery of the connecting portion 74 of the anvil shaft 71 and disposed adjacent to the first support ring 63.

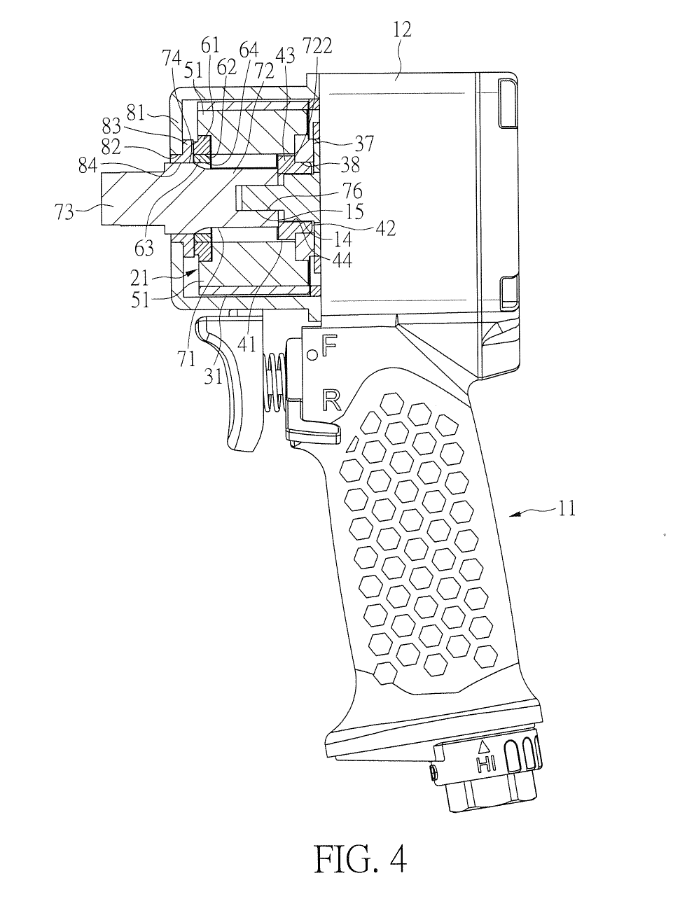

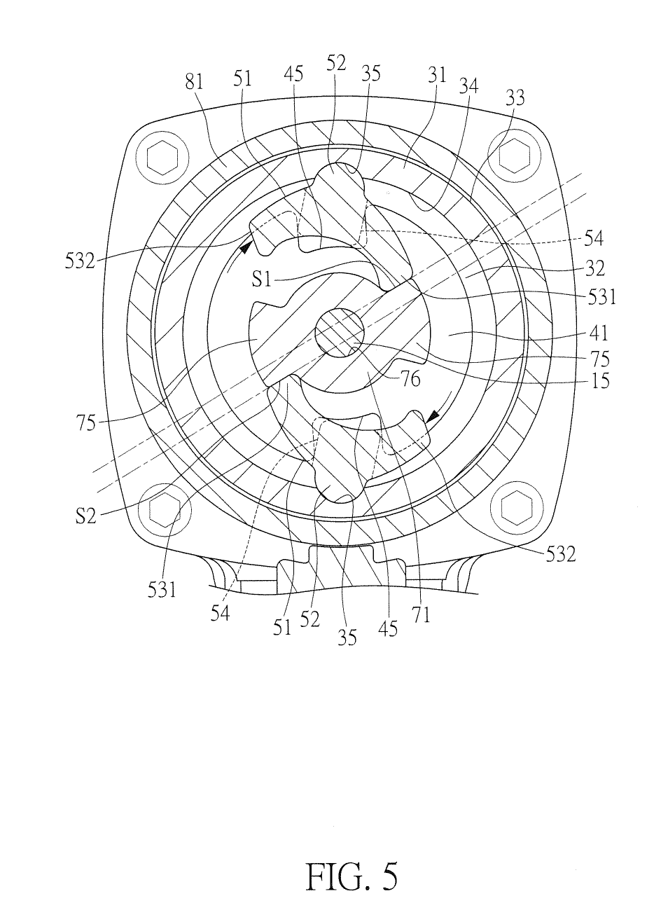

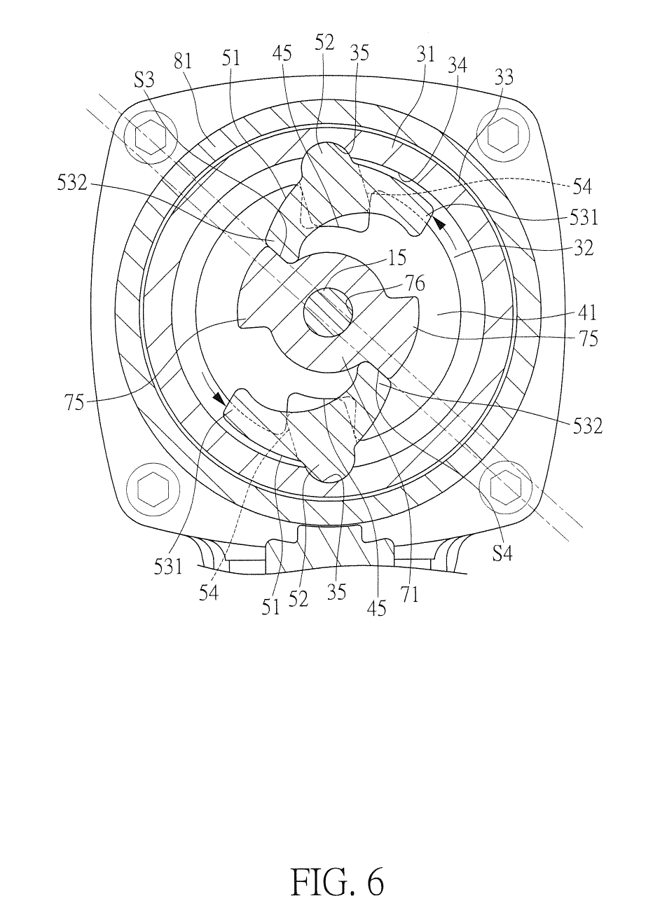

With reference to FIGS. 4 and 5 for a pneumatic tool having an impact module with dual impact members in accordance with the present invention, the pivoting portions 52 of the two impact members 51 of the pneumatic tool are respectively and pivotally installed into the two pivoting slots 35 of the inner wall 34 of the rotating socket 31, and the limit protrusions 54 of the two impact members 51 are latched into the two limit slots 45 of the transmission seat 41 respectively. In other words, the rotating socket 31 and the transmission seat 41 are latched with each other by the two impact members 51, so that when the driving shaft 13 drives the transmission seat 41 to rotate in forward and reverse directions, the two impact members 51 and the rotating socket 31 will be rotated in the forward and reverse directions as well. In FIG. 5, when the two impact members 51 rotate in a forward (clockwise) rotation, the impact members 51 will be pivoted by using the pivoting portion 52 as an axis, and the forward striking portions 531 of the two impact members 51 in the rotating direction also strike the anvil portion 75 of the anvil shaft 71, and the forward striking portions 531 of the two impact members 51 strike the anvil portion 75 of the anvil shaft 71, wherein a first striking surface S1 and a second striking surface S2 are formed and defined at cross-sectional positions respectively, and the first striking surface S1 and the second striking surface S2 are parallel to each other (as shown in the dotted line of FIG, 5). In FIG. 6, when the two impact members 51 rotate in a reverse (counterclockwise) direction, the two impact member 51 will be pivoted by using the pivoting portion 52 as an axis, such that the reverse striking portions 532 of the two impact members 51 in the rotating direction also strike the anvil portion 75 of the anvil shaft 71, and the reverse striking portions 532 of the two impact members 51 strike the anvil portion 75 of the anvil shaft 71, wherein a third striking surface S3 and a fourth striking surface S4 are formed and defined at cross-sectional positions respectively, and the third striking surface S3 and the fourth striking surface S4 are parallel to each other (as shown in the dotted line of FIG. 6). It is noteworthy that the aforementioned cross-section refers to a cross section of the anvil shaft 71 obtained by cutting the anvil shaft 71 along a direction perpendicular to the axis of the anvil shaft 71.

If the torque produced by the striking by the two impact members 51 is insufficient to drive the anvil shaft 71 to rotate, the two impact members 51 will be pivoted in opposite directions with respect to each other, so that the forward striking portion 531 (or the reverse striking portion 532) will be separated from the anvil portion 75 corresponsive to the anvil shaft 71, and then the two impact members 51 will continue to rotate, and the forward striking portion 531 (or the reverse striking portion 532) will strike the anvil portion 75 of the anvil shaft 71 to generate an impact force again. Therefore, the transmitting end 73 of the anvil shaft 71 is capable of generating a rotation power with an impact effect. In addition, the forward striking portion 531 of the two impact members 51 has a protruding length P1 greater than the protruding length P2 of the reverse striking portion 532, and thus the forward striking portion 531 and the reverse striking portion 532 of the two impact members 51 have different impact strokes in the forward and reverse rotation processes respectively. In other words, the reverse striking portion 532 has a relatively smaller protruding length P2, so that the stroke distance of the reverse striking portion 532 striking at the anvil portion 75 of the anvil shaft 71 is greater than the stroke distance in the forward rotation in the reverse rotation process of the two impact members 51, so that a greater torque will be outputted during the reverse rotation, so as to produce a greater torque output while loosening the screw in an opposite direction and make the job of loosening the screw more efficiently to meet the requirements of practical use.

In FIG. 4, the bottom side 722 of the actuating end 72 of the anvil shaft 71 of the present invention abuts the receiving end 43 of the transmission seat 41, and the driving shaft 13 further includes an extension 15 extended outwardly and passed into the circular hole 76 of the bottom side 722 of the actuating end 72 of the anvil shaft 71, and the extension 15 passes into the circular hole 76 to a length greater than half of the depth of the circular hole 76, so as to ensure that the actuating end 72 of the anvil shaft 71 is limited by the extension 15 to prevent it from shaking or being deviated when the anvil portion 75 of the actuating end 72 of the anvil shaft 71 is struck. In addition, the connecting portion 74 of the anvil shaft 71 is sheathed on the first support ring 63 of the latch ring 61 and the second support ring 83 of the housing 81 to further ensure that the precision of the rotation of the anvil shaft 71 to prevent the anvil shaft 71 from being shaken or deviated during the rotation. Therefore, the forward striking portions 531 (or the reverse striking portions 532) of the two impact members 51 can strike the anvil portion 75 of the anvil shaft 71 at the same time in each striking process to ensure the output performance.

In the pneumatic tool having an impact module with dual impact members in accordance with the present invention, the rotating socket 31 is in a hollow cylindrical form, and thus making the manufacturing, assembling and disassembling processes very easy and providing an excellent structural strength without increasing the volume of impact module too much. In addition, the rotating socket 31 of the present invention has two symmetric impact members 51, so that it is unnecessary to add a weight portion at the eccentric position of the rotating socket 31 in order to achieve stable rotations of the whole impact module 21 and prevent the impact module 21 from being shaken easily. Since the two impact members 51 and its pivoting portion 52, forward striking portion 531, reverse striking portion 532 and limit protrusion 53 are components which are integrally connected to one another, therefore an excellent structural strength and an easy manufacture of impact member 51 can be achieved, and the expected precision requirement can be met easily.

1. A pneumatic tool having an impact module with dual impact members, comprising:
a handle, having a driving motor installed at an end of the handle, a driving shaft protruded outwardly from the driving motor, and a driving section and a cylindrical extension with an external diameter smaller than the driving section sequentially formed along the protruding direction of the driving shaft;
an impact module, with an end coupled to the driving shaft of the driving motor, and including a rotating socket, a transmission seat, two impact members, a latch ring and an anvil shaft, and the rotating socket having a rotating space formed therein, and an outer wall and an inner wall, and the rotating space and the rotating socket being configured coaxially with each other, and two symmetrical pivoting slots being concavely formed on the inner wall, and an opening being formed at an end of the rotating socket and interconnected to the rotating space, and a rear side being formed at another end of the rotating socket, and a via is formed at the center of the rear side of the rotating socket and interconnected to the rotating space, and an end of the transmission seat being disposed corresponsive to the via of the rotating socket, an embedding hole being formed at the center of the transmission seat, and the driving section of the driving shaft being embedded into the embedding hole and capable of driving the transmission seat to rotate, and two limit slots concavely formed at another end of the transmission seat and in opposite directions with respect to each other;
each of the two impact members having an integrally connected pivoting portion, a forward striking portion protruded from a side of the pivoting portion, a reverse striking portion protruded from another side of the pivoting portion, and a limit protrusion, and the forward striking portion having a protruding length greater than the protruding length of the reverse striking portion, and the pivoting portions of the two impact members being respectively and pivotally installed into the two pivoting slots of the rotating socket, and the limit protrusions being latched into the two limit slots of the transmission seat respectively, and the forward striking portion of one of the two impact members being arranged opposite to the reverse striking portion of the other impact member, and the latch ring being covered onto the opening of the rotating socket, and a through hole being formed at the center of the latch ring and interconnected to the rotating space;
the anvil shaft has an actuating end and a transmitting end disposed opposite to the actuating end, and the actuating end of the anvil shaft axially passes into the rotating space of the rotating socket through the through hole of the latch ring and abuts the transmission seat, and the actuating end has a circumferential surface and a bottom side abutting at the transmission seat, two anvil portions formed and protruded from the forward striking portion and the reverse striking portion at the circumferential surface and corresponsive to the two impact members respectively, and a circular hole concavely formed axially at the center of the bottom side of the actuating end, and the cylindrical extension of the transmission shaft passes into the circular hole, and the cylindrical extension passes into the circular hole to a length greater than half of the depth of the circular hole;
when the driving shaft drives the transmission seat to rotate, the two impact members and the rotating socket are rotated altogether, and the forward striking portions of the two impact members strike the corresponsive anvil portion of the anvil shaft simultaneously in a forward rotation process, and a first striking surface and a second striking surface are defined at cross-sectional positions respectively, and the first striking surface and the second striking surface are configured to be parallel to each other, and the reverse striking portions of the two impact members strike the corresponsive anvil portion of the anvil shaft simultaneously in a reverse rotation process, and a third striking surface and a fourth striking surface are defined at cross-sectional positions respectively, and the third striking surface and the fourth striking surface are configured to be parallel to each other.

2. The pneumatic tool having an impact module with dual impact members as claimed in claim 1, wherein the two pivoting slots are concavely formed on two opposite sides of the inner wall of the rotating socket respectively and extended parallel to the axial direction of the rotating socket.

3. The pneumatic tool having an impact module with dual impact members as claimed in claim 1, wherein the transmission seat has an installing end formed at an end thereof and a receiving end expanded outwardly and formed at another end thereof, and the installing end of the transmission seat is passed through the opening of the rotating socket and installed into the via of the rear side of the rotating socket, and the bottom side of the anvil shaft abuts the receiving end of the transmission seat.

4. The pneumatic tool having an impact module with dual impact members as claimed in claim 1, wherein the through hole includes a first support ring installed therein, and the first support ring has a circular first support surface formed around an interior of the first support ring, and the first support ring has a peripheral shape corresponsive to the shape of the through hole, and a connecting portion is defined between the actuating end and the transmitting end, and the connecting portion has a shape corresponsive to the shape of the first support surface of the first support ring, and when the bottom side of the actuating end of the anvil shaft and the transmission seat abut against each other, the first support ring of the latch ring is sheathed on the connecting portion of the anvil shaft.

5. The pneumatic tool having an impact module with dual impact members as claimed in claim 4, further comprising a housing covered onto an external periphery of the impact module and coupled to the driving motor, and having a transmission hole formed at an end of the housing, and the transmitting end of the anvil shaft being passed through the transmission hole and exposed from the housing, and the transmission hole of the housing having a second support ring installed therein, and a circular second support surface formed around an interior of the second support ring, and the second support surface and the first support surface having the same shape and the same size, and when the housing and the driving motor are coupled to each other, the second support ring of the housing is sheathed on the connecting portion of the anvil shaft, and the first support ring is disposed adjacent to the second support ring.
